(19) United States
(12) Patent Application Publication
(10) Pub. No.: US 2014/0002376 A1
(43) Pub. Date: Jan. 2, 2014

(54) METHOD AND APPARATUS FOR PROVIDING SHORTCUT TOUCH GESTURES WITH HAPTIC FEEDBACK

(71) Applicants: Hugues-Antoine Oliver, Montreal (CA); Herve Thu Timone, Candiac (CA)

(72) Inventors: Hugues-Antoine Oliver, Montreal (CA); Herve Thu Timone, Candiac (CA)

(73) Assignee: IMMERSION CORPORATION, San Jose, CA (US)

(21) Appl. No.: 13/539,230

(22) Filed: Jun. 29, 2012

(51) Int. Cl. G06F 3/041

(52) U.S. Cl. 345/173

(57) ABSTRACT

An electronic device for triggering an action based on a shortcut gesture. The electronic device may include a user interface, a haptic device, and a controller in signal communication with the user interface and the haptic device. The user interface may be configured to receive a touch gesture at its surface. The controller is configured to determine a recognition level of the touch gesture as the touch gesture is being received. It is configured to trigger the haptic device to generate a haptic effect at the user interface based on the recognition level, and it is configured to trigger an application action associated with the touch gesture if the recognition level exceeds a threshold.

### FIELD OF THE INVENTION

The invention relates to a method and apparatus for providing shortcut touch gestures with haptic feedback.

### BACKGROUND OF THE INVENTION

Some mobile devices such as phones are known to allow users to dial a phone number through a touch screen. In some cases, after a user launches a phone dialing application, the user may have to touch a number key on a keypad presented on the screen, repeat that operation many more times to input a complete phone number, and touch a button on the screen to initiate dialing of the inputted phone number. In some cases, a user may be able to touch a shortcut key, such as a speed dial button presented on the keypad, to trigger dialing of a phone number associated with the speed dial button. If the keypad is small or if the user looks away from the screen, however, the user may make a mistake in dialing the phone number.

### SUMMARY

According to an aspect of the present invention, there is provided an electronic device comprising a user interface, a haptic device, and a controller. The user interface may be configured to receive a touch gesture at a surface of the user interface. The touch gesture may comprise a continuous movement on the surface. The haptic device may be configured to generate a haptic effect at the user interface. The controller may be in signal communication with the user interface and the haptic device. The controller may be configured to determine a recognition level of the touch gesture as the touch gesture is being received at the user interface, and may be configured to trigger the haptic device to generate a haptic effect as the touch gesture is being received at the user interface. The haptic effect may be based on the recognition level. The controller may be further configured to trigger an application action associated with the touch gesture if the recognition level exceeds a threshold.

According to an aspect of the invention, the controller may be configured to determine the recognition level of the touch gesture by comparing a loci of points on the surface as the touch gesture is being received with a symbol associated with the application action.

According to an aspect of the invention, comparing the loci of points with the symbol may include detecting a direction at which the touch gesture is received at the surface.

According to an aspect of the invention, comparing the loci of points with the symbol may include determining a rate at which the touch gesture is received at the surface.

According to an aspect of the invention, the symbol may be selected from the group consisting of: a line, a checkmark, a cross, a circle, a triangle, and a square.

According to an aspect of the invention, the application action associated with the touch gesture may comprise a communication action that uses a phone number associated with the symbol.

According to an aspect of the invention, the controller may be configured to trigger the haptic device to generate a haptic effect that simulates a coefficient of friction when the recognition level of the touch gesture is low, and to generate a second haptic effect that simulates a texture when the recognition level of the touch gesture is high.

According to an aspect of the invention, the controller may be configured to trigger the haptic device to generate the first haptic effect during a first time period when the touch gesture is being received and to generate the second haptic effect during a second time period when the touch gesture is being received.

According to an aspect of the invention, the first haptic effect may have a higher frequency and/or a lower magnitude compared to the second haptic effect.

These and other aspects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 schematically illustrates an apparatus in accordance with an embodiment of the invention.

FIG. 2A schematically illustrates symbols that represent predetermined shortcut touch gestures for the apparatus of FIG. 1.

FIG. 2B schematically illustrates a touch gesture applied to the apparatus of FIG. 1.

FIG. 3 schematically illustrates a method in accordance with an embodiment of the invention.

### DETAILED DESCRIPTION

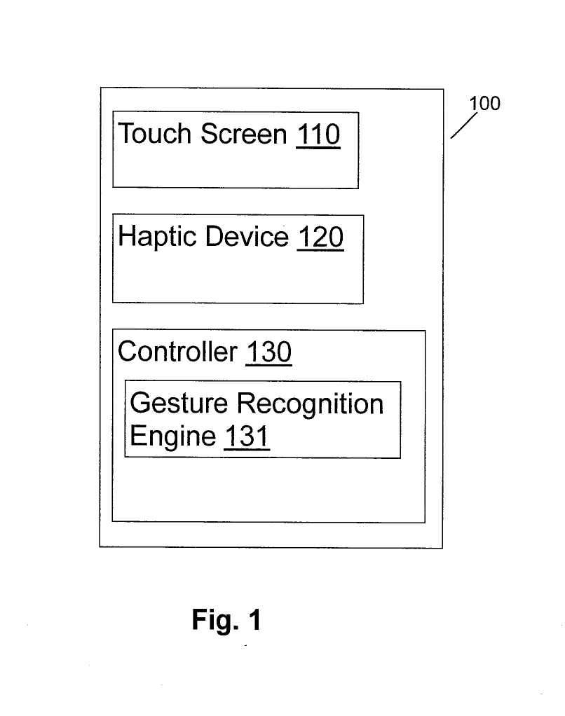

FIG. 1 illustrates an embodiment of an electronic device 100 that may trigger an application action based on a touch gesture. Rather than having to trigger an application action through multiple touch inputs, such as touching a menu button to access a menu of an application, followed by touching an option on the menu to select an action to trigger, and followed by touching a command button to trigger the selected action, the user may apply the touch gesture as a shortcut to triggering the action. The user's touch gesture may correspond to one or more predetermined shortcut touch gestures, which may have been predetermined by a device vendor or by the user.

Further, a haptic effect may be generated to let a user know whether a touch gesture being applied by that user is close to one or more predetermined shortcut touch gestures. Each predetermined shortcut touch gesture may be associated with an application action, and applying the shortcut gesture may trigger the associated action. As a user's touch gesture comes closer to matching a predetermined shortcut touch gesture, the haptic effect may be varied to reflect, for example, an increasing similarity between the user's touch gesture and the predetermined shortcut touch gesture. A user may thus be able to gauge through the haptic effect whether his or her touch gesture will be recognized by device 100.

In an embodiment, as illustrated in FIG. 1, device 100 may include a touch screen 110 or any other touch-sensitive interface, a haptic device 120, and a controller 130. Touch screen 110 may be configured to sense a touch input on the screen and one or more locations on the screen at which the touch input is received. The touch screen may be configured to sense touch input from a finger, a stylus, or any combination thereof. In an embodiment, the touch input may be a touch gesture. A touch gesture may be, for example, a touch input that makes one or more continuous movements on screen 110. If the touch gesture includes a plurality of continuous movements on screen 110, the plurality of movements may be made sequentially or simultaneously. Simultaneous movements may come from, for example, two fingers both moving on screen 110. In an embodiment, device 100 may have a touch pad instead of or in addition to a touch screen.

Haptic device 120 of device 100 may be configured to generate a haptic effect at a surface of touch screen 110 or at any other location of device 100. As discussed below, the haptic effect generated by haptic device 120 may be based on a touch gesture received at screen 110. Haptic device 120 may include piezoelectric material, a motor, a voice coil, an electrostatic device, a solenoid, a fiber of electroactive polymers (EAP), an ultrasonic energy actuator, an eccentric mass actuator, or any combination thereof.

Controller 130 of device 100 may be operatively coupled to touch screen 110 and to haptic device 120, and may be configured to trigger the haptic device to generate a haptic effect. The haptic effect generated by haptic device 120 may be based on a level to which controller 130 recognizes a user's touch gesture, which may be based on how closely the user's touch gesture matches one or more predetermined shortcut touch gestures. In an embodiment, this recognition level may be determined by a gesture recognition engine 131 implemented in controller 130. As more of the touch gesture is received, the recognition level may increase because the touch gesture may match more of a predetermined shortcut touch gesture. If the touch gesture matches, in whole or in part, more than one predetermined touch gesture, the recognition level may be based on the predetermined touch gesture that most closely matches the touch gesture. Change in the recognition level may be used by controller 130 to trigger the haptic device to change a haptic effect being generated at screen 110. The change in the haptic effect may indicate to a user whether his or her touch gesture is close to matching one of the predetermined shortcut touch gestures of device 100. Controller 130 may include a microprocessor, logic circuit, or any other computing circuitry.

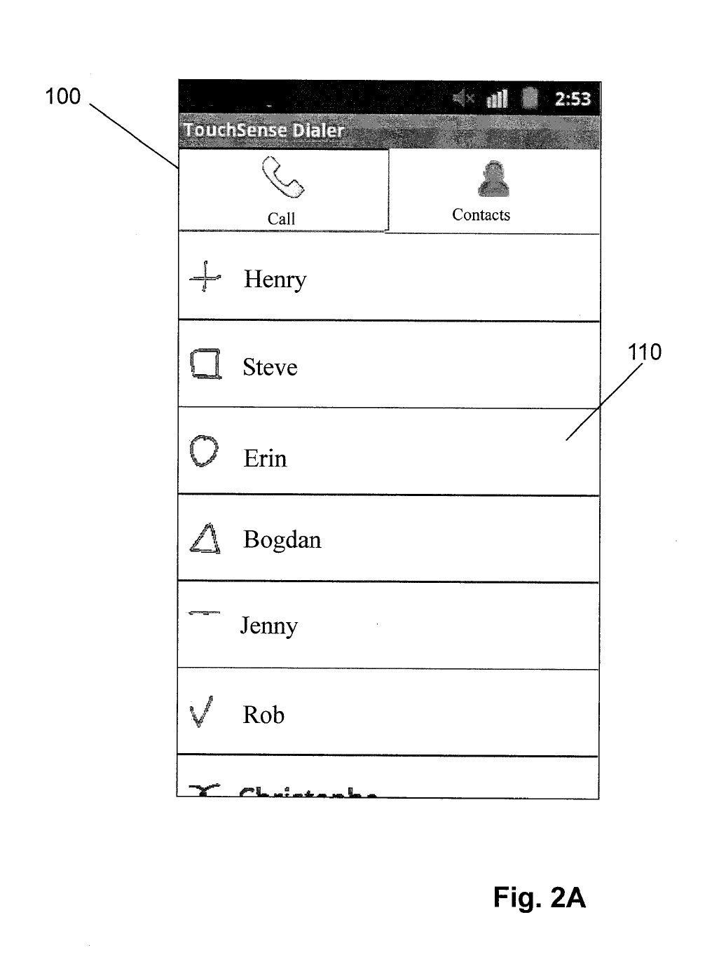

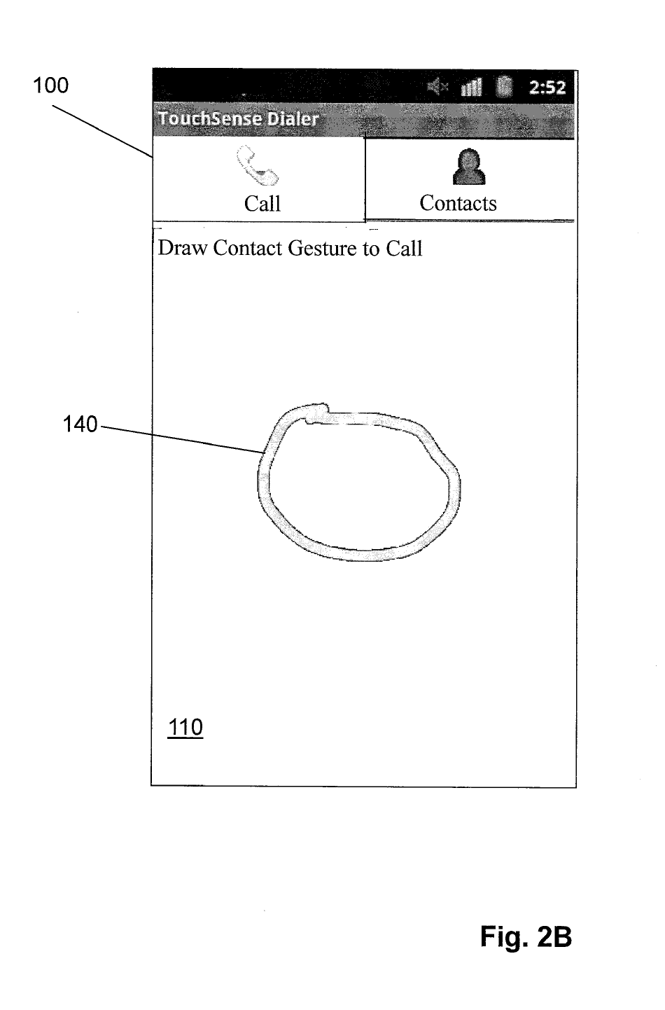

A predetermined shortcut touch gesture may be represented by a symbol. Some symbols are illustrated on an example view of touch screen 110 of device 100 in FIG. 2A. FIG. 2A shows multiple symbols that may each represent a predetermined shortcut touch gesture. The symbols include a cross, a square, a circle, a triangle, a horizontal line, and a check mark. Other symbols may include a vertical line, a diagonal line, a pentagon, a rectangle, or any other geometrical figure (e.g., a figure defined by a polynomial) or shape. In an embodiment, a user may be able to form a new symbol by moving his or her finger on screen 110. As discussed in more detail below, a predetermined shortcut touch gesture may further be represented by a direction, rate, or size at which the symbol is formed. A circle symbol that is formed in a clockwise direction, for example, may represent a different predetermined shortcut touch gesture than a circle symbol that is formed in a counterclockwise direction. A circle symbol that is formed at one rate may represent a different predetermined shortcut touch gesture than a circle symbol that is formed at, for example, a faster rate. In an embodiment, a predetermined shortcut touch gesture may be associated with an amount of pressure by which the touch gesture is applied. For example, forming a line symbol while applying one level of pressure may represent a different shortcut than forming the line symbol while applying a higher level of pressure.

A user may apply a predetermined shortcut touch gesture by forming its representative symbol on screen 110. FIG. 2B illustrates an example in which symbol 140 is formed on screen 110. As discussed in more detail below, one application action that a predetermined shortcut touch gesture may be associated with includes dialing of a phone call to a desired recipient. The predetermined shortcut touch gesture allows the phone call to be dialed without needing a keypad. In the illustration of FIG. 2B, applying the predetermined shortcut touch gesture represented by symbol 140 may trigger dialing of a phone call to Erin, the recipient associated with the predetermined shortcut touch gesture.

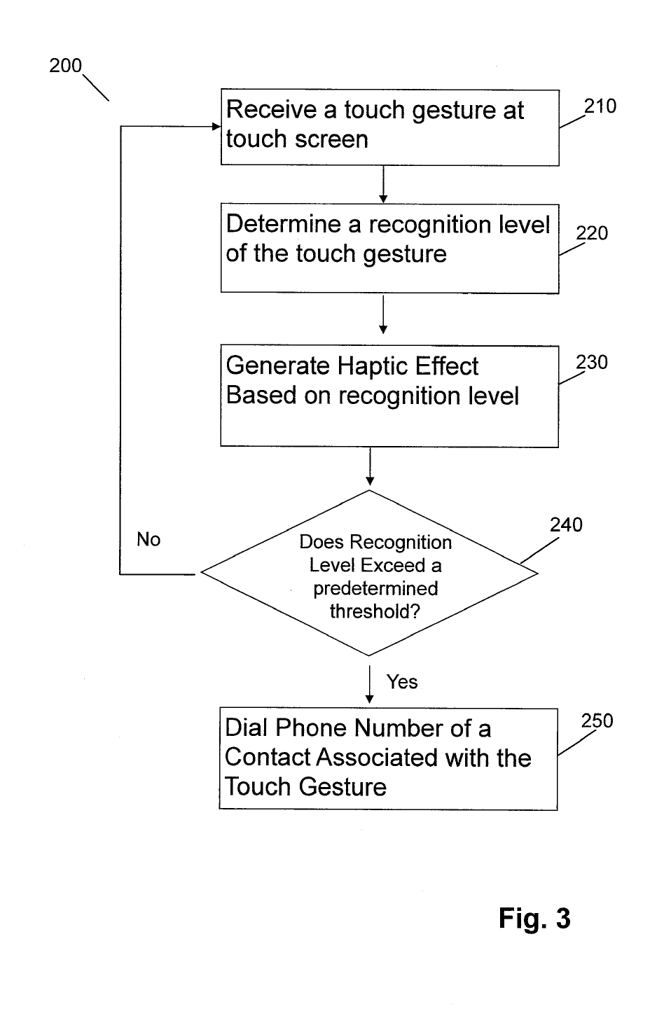

More details for triggering an application action are presented in FIG. 3, which illustrates a method 200 for triggering an application action based on a touch gesture. The method may provide a faster or more convenient way of triggering an application action, which may be associated with a predetermined shortcut touch gesture. If a user applies a touch gesture that is recognized as the predetermined shortcut touch gesture, the application action associated with the predetermined shortcut touch gesture may be triggered.

At operation 210, the user's touch gesture may be received at a surface of a user interface of an electronic device. The user interface may be touch screen 110 of device 100 or may be any other user interface. The touch gesture may include one or more continuous movements of a finger, stylus, or other object at a surface of the user interface. The movement may be represented as a loci of points at which the surface has been touched or is being touched. For example, the touch gesture illustrated in FIG. 2B may be represented as a loci of points that are indicative of a circular movement. The loci of points may be tracked by gesture recognition engine 131 of controller 130, or by any other computing device. Gesture recognition engine 131 may, for example, sample screen 110 for a current location at which screen 110 is being touched, and may update the loci of points with the current location. A higher sampling rate (e.g., 100 Hz) may be selected when greater granularity of the touch gesture's movement is needed, while a lower sampling rate (e.g., 10 Hz) may be selected to reduce power consumption. A timestamp may be associated with each point to track a direction and rate of the touch gesture's movement.

A touch gesture may include a temporary break in contact between the finger, stylus, or other object with the surface of the user interface. For example, for applying a touch gesture represented by the cross symbol illustrated in FIG. 2A, the movement of the touch gesture may require a user to temporarily lift his finger between forming a first line of the symbol and a second line of the symbol. Operation 210 may distinguish whether the break in contact is part of the touch gesture, or whether the break in contact indicates that the touch gesture has been completed. In an embodiment, operation 210 may include determining how long the break in contact lasts. If the break in contact lasts less than a threshold, such as several hundred milliseconds or one second, the break in contact may be determined to be part of the touch gesture.

As a touch gesture is being received at operation 210, a recognition level of the touch gesture may be determined at operation 220. The recognition level may be determined by gesture recognition engine 131 or by any other computing device. In an embodiment, the recognition level may indicate a level to which the touch gesture being received from the user matches one or more predetermined shortcut touch gestures. If the one or more predetermined shortcut touch gestures are represented by one or more symbols, determining the recognition level may be based on comparing the touch gesture to the one or more symbols. More particularly, the one or more symbols may be compared to the loci of points that represent the touch gesture's movement. For example, each of the symbols illustrated in FIG. 2A may be compared to the loci of points formed by the touch gesture illustrated in FIG. 2B. The recognition level may vary based on how much of the touch gesture has been received. For the touch gesture illustrated in FIG. 2B, a loci of points during a first part of the gesture's movement may form a quarter circle, while the loci of points during a later part of the gesture's movement may form a semicircle. The recognition level may increase during the movement to reflect a greater level to which the loci of points matches the circle symbol, which represents the predetermined shortcut touch gesture for dialing a call to Erin.

In another example, a touch gesture's movement may create a loci of points that form a line. Here, a recognition level may increase during the movement because of an increasing similarity between the loci of points and the symbol that represents the predetermined shortcut touch gesture for dialing a call to Jenny. However, if the movement of the touch gesture continues, such as by moving in a vertical direction, the recognition level may decrease to a lower level because the loci of points during that part of the movement now has a decreasing similarity to the symbol associated with dialing a call to Jenny. However, the recognition level may increase from that lower level if the movement continues on to form a square, which represents the predetermined shortcut touch gesture for dialing a call to Steve. If the movement continues further, after it has formed a square, the recognition level may decrease again. It may decrease in proportion to how much the loci of points now deviates from the square symbol, or may directly decrease to a minimal level because the loci of points will now be unable to match any of the symbols illustrated in FIG. 2A.

Determining the recognition level at operation 220 may also be based on, in an embodiment, a direction of the movement of the touch gesture being received, a rate of the movement, a size of the touch gesture, or any combination thereof. For example, if a predetermined shortcut touch gesture is represented by a circle symbol formed in a clockwise manner, a touch gesture that moves in a counterclockwise manner may not be able to reach a maximum recognition level. In another example, if a predetermined shortcut touch gesture is represented by a cross symbol that forms a vertical line after a horizontal line is formed, a touch gesture that moves in a vertical direction before it moves in a horizontal direction may not be able to reach a maximum recognition level.

If determining the recognition level is based on a rate of movement, the determining may examine whether the rate falls within one or more ranges. If determining the recognition level is based on a size of the touch gesture, the determining may examine whether the size falls within one or more ranges. The size of the touch gesture may be based on a range of coordinates occupied by the loci of points of the touch gesture's movement or may be based on any other metric.

In an embodiment, a shortcut touch gesture may have to be made within a maximum elapsed time. For example, determining the recognition level may be based on only the loci of points that have been received within a time window. Movement detected outside the time window may be considered part of a separate predetermined shortcut touch gesture. Limiting the elapsed time during which a shortcut gesture can be made may reduce a chance of erroneous recognitions. For example, if a user's hand accidentally grazes touch screen 110, any loci of points made by the hand movement during the grazing will be excluded from a loci of points used to recognize an intentional touch gesture that the user makes at a much later time. Thus, if the user's grazing motion makes an incomplete, unrecognized circle and no further touch input is received within a maximum elapsed time, any attempt to recognize the touch gesture may then be reset and any loci of points from the grazing motion will not be considered for recognizing future touch gestures.

After the recognition level is determined, a haptic effect may be generated at operation 230 based on the recognition level. The haptic effect may include a vibration, thermal effect, electrostatic effect, or any other haptic effect. In an embodiment, as the recognition level is updated, the haptic effect may be updated. For example, if a recognition level is initially at a minimal value because the touch gesture is just being received, no haptic effect may be applied. As the recognition level increases, the haptic effect may be configured to simulate a friction at the user interface that is additional to the natural friction from the surface of the user interface. That is, the haptic effect may simulate one or more coefficients of friction at the user interface surface. If the recognition level continues increasing, the haptic effect may transition to simulating a texture that may be different from the natural texture of the surface of the user interface. If the recognition level decreases, such as when the loci of points of the touch gesture's movement deviates from all predetermined shortcut touch gestures, the haptic effect may transition again, such as to an electrostatic or thermal effect.

In an embodiment, simulating a friction or a texture may be based on varying a frequency or amplitude of a haptic effect. For example, the haptic effect that simulates a coefficient of friction may have a higher frequency and lower amplitude than the haptic effect that simulates a texture. In a more specific example, the coefficient of friction may be simulated with a vibration haptic effect at a frequency of 500 Hz and a magnitude that is 20% of a maximum magnitude. The texture may be simulated with a vibration haptic effect at a frequency of 100 Hz and at the maximum magnitude. For both haptic effects, the vibration may be applied in bursts that are spaced, for example, four milliseconds apart.

As the touch gesture is being received or after it has been received, an application action associated with the touch gesture may be triggered at operation 250 if the recognition level exceeds a threshold, as determined at operation 240. If the recognition level fails to exceed a threshold, the touch gesture may be too incomplete to sufficiently match a predetermined shortcut touch gesture, or may deviate too much from all of the predetermined shortcut touch gestures. Method 200 may then continue receiving the touch gesture at operation 210. If predetermined shortcut touch gestures are represented by symbols, one example threshold may require a user's touch gesture to match no more than one of the symbols and may require the match to be sufficiently high (e.g., the touch gesture must form at least 90% of the symbol). In some cases, the threshold level may be customized by a user.

The application action that is triggered may include launching of an application by an operating system, activating a voice command mode, playing of a song having a certain title, artist, or album, or, as illustrated in FIGS. 2A-2B, initiating a phone-based connection with a recipient associated with a predetermined shortcut touch gesture. Initiating the phone-based connection may include dialing the recipient's phone number, presenting a text messaging interface that has the recipient's phone number in a destination field, or presenting an e-mail or social media interface that has the recipient's contact information in the destination field.

In the embodiments described above, device 100 may be a mobile device, a remote control, a tablet, desktop, or notebook computer, electronic display, or any other electronic device. Controller 130 may include a microprocessor, logic circuit, or any other computing circuitry. Operations of method 200 may be performed in any order, or may be performed concurrently.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A method for triggering an action based on a shortcut gesture, the method comprising:
receiving a touch gesture at a surface of a user interface of an electronic device, the touch gesture comprising a continuous movement on the surface;
determining a recognition level of the touch gesture during the receiving;
generating a haptic effect at the user interface during the receiving based on the recognition level; and
triggering an application action associated with the touch gesture if the recognition level exceeds a threshold.

2. The method of claim 1, wherein the determining the recognition level of the touch gesture comprises comparing a loci of points on the surface as the touch gesture is being received with a symbol associated with application action.

3. The method of claim 2, wherein the comparing the loci of points with the symbol comprises detecting a direction at which the touch gesture is received at the surface.

4. The method of claim 3, wherein the comparing the loci of points with the symbol comprises determining a rate at which the touch gesture is received at the surface.

5. The method of claim 2, wherein the symbol is selected from the group consisting of: a line, a checkmark, a cross, a circle, a triangle, and a square.

6. The method of claim 2, wherein the application action associated with the touch gesture comprises a communication action that uses a phone number associated with the symbol.

7. The method of claim 1, wherein the generating the haptic effect comprises generating a first haptic effect that simulates a coefficient of friction when the recognition level of the touch gesture is low, and generating a second haptic effect that simulates a texture when the recognition level of the touch gesture is high.

8. The method of claim 7, wherein the first haptic effect is generated during a first time period when the touch gesture is being received, and wherein the second haptic effect is generated during a second time period when the touch gesture is being received.

9. The method of claim 7, wherein the first haptic effect has a higher frequency and/or a lower magnitude compared to the second haptic effect.

10. An electronic device comprising:
a user interface configured to receive a touch gesture at a surface of the user interface, the touch gesture comprising a continuous movement on the surface;
a haptic device configured to generate a haptic effect at the user interface; and
a controller in signal communication with the user interface and the haptic device, the controller configured to
determine a recognition level of the touch gesture as the touch gesture is being received at the user interface,
trigger the haptic device to generate a haptic effect as the touch gesture is being received at the user interface, the haptic effect based on the recognition level, and
trigger an application action associated with the touch gesture if the recognition level exceeds a threshold.

11. The electronic device of claim 10, wherein the controller is configured to determine the recognition level of the touch gesture by comparing a loci of points on the surface as the touch gesture is being received with a symbol associated with the application action.

12. The electronic device of claim 11, wherein the controller is configured to compare the loci of points with the symbol by detecting a direction at which the touch gesture is received at the surface.

13. The electronic device of claim 12, wherein the controller is configured to compare the loci of points with the symbol by determining a rate at which the touch gesture is received at the surface.

14. The electronic device of claim 11, wherein the symbol is selected from the group consisting of: a line, a checkmark, a cross, a circle, a triangle, and a square.

15. The electronic device of claim 11, wherein the application action associated with the touch gesture comprises a communication action that uses a phone number associated with the symbol.

16. The electronic device of claim 10, wherein the controller is configured to trigger the haptic device to generate a first haptic effect that simulates a coefficient of friction when the recognition level of the touch gesture is low, and to generate a second haptic effect that simulates a texture when the recognition level of the touch gesture is high.

17. The electronic device of claim 16, wherein the controller is configured to trigger the haptic device to generate the first haptic effect during a first time period when the touch gesture is being received and to generate the second haptic effect during a second time period when the touch gesture is being received.

18. The electronic device of claim 16, wherein the first haptic effect has a higher frequency and/or a lower magnitude compared to the second haptic effect.

19. A mobile communication device, comprising:
a user interface configured to receive a touch gesture at a surface of the user interface, the touch gesture comprising a continuous movement on the surface; and
a controller in signal communication with the user interface, the controller configured to
determine whether the touch gesture is associated with a symbol, and
cause a transmission of a communication to a communication recipient associated with the symbol.

20. The mobile communication device of claim 19, wherein the symbol is selected from the group consisting of: a line, a checkmark, a cross, a circle, a triangle, and a square.
